(19) United States
(12) Patent Application Publication
(10) Pub. No.: US 2022/0347058 A1
(43) Pub. Date: Nov. 3, 2022

(54) THERMOCHROMIC NIPPLE SHIELD AND ASSOCIATED SYSTEMS AND METHODS

(71) Applicant: Ceres Chill, Inc., Bainbridge Island, WA (US)

(72) Inventor: Elizabeth J. Myers, Bainbridge Island, WA (US)

(21) Appl. No.: 17/733,455

(22) Filed: Apr. 29, 2022

Related U.S. Application Data
(60) Provisional application No. 63/181,877, filed on Apr. 29, 2021.

(51) Int. Cl. A61J 13/00

(52) U.S. Cl. CPC A61J 13/00; A61J 2200/72

(57) ABSTRACT

Disclosed is a nipple shield for covering a nipple and surrounding area during breastfeeding. The nipple shield includes a flexible, thin barrier having a shape that conforms with the nipple and surrounding area of a person breastfeeding. The nipple shield includes a cone portion, a base portion surrounding the cone portion and a plurality of extraction holes extending through a top region of the cone portion to allow an infant to extract milk during breastfeeding. At least a portion of the nipple shield includes a thermochromic material configured to change the visibility of the barrier at a threshold temperature. The thermochromic material is transparent when the temperature of the barrier is at or above a body temperature and the thermochromic material is partially opaque and has a visible color when the temperature of the barrier is below the body temperature.

### CROSS-REFERENCE TO RELATED APPLICATION(S)

This application claims the benefit of U.S. Provisional Patent Application No. 63/181,877, entitled “THERMOCHROMIC NIPPLE SHIELD,” filed on Apr. 29, 2021, which is incorporated herein by reference in its entirety.

### TECHNICAL FIELD

The present technology relates to a nipple protection device for breastfeeding and, in particular, a thermochromic nipple shield and associated systems and methods.

### BACKGROUND

Breastfeeding, also termed chestfeeding, can be challenging and painful for parents. Securing sufficient nutrients from the act of nursing can sometimes be difficult for infants. Infants and nursing parents may have physical conditions that make repeated nursing and sustained, direct contact of the infant's mouth with the nipple difficult. In addition, improper latching of the infant to the breast, whether that is due to a physical limitation or other reason, commonly causes sores and pain. The pain or discomfort experienced during nursing can interfere with the ability of parents to continue breastfeeding. Healthcare providers, lactation consultants, or other professionals will often recommend a nipple shield to parents to encourage continued breastfeeding and minimize pain. Parents who want to continue breastfeeding but are in pain may choose to use a nipple shield for some or all the time they breastfeed their babies to alleviate some of the discomfort they feel when nursing.

Conventional nipple shields are typically smooth, clear pieces of silicone that fit over the nipple and surrounding area. The upper cone, which is the area into which the nipple is inserted, typically has several holes at the top of the cone center to allow for breastmilk transmission to the infant. The infant latches onto the area covered by the nipple shield, which serves to alleviate some of the discomfort that may otherwise be experienced when the infant latches on with its mouth on the parent's bare skin. The infant's ability to latch onto the nipple shield also serves to facilitate the transfer of nutrients, for instances when there are infant tongue ties or parental inverted nipples.

Conventional nipple shields have a variety of shortcomings. For example, the base portion of nipple shields—the flatter area that lies against the mother's breast—covers the breast with a smooth, impermeable surface. When nursing and using this type of nipple shield, the infant's face and nose are placed directly against a smooth, artificial barrier without allowing the infant to breathe the parent's scent and feel a texture more consistent with human breast skin. This can make introduction and use of a nipple shield quite challenging. Further, when the infant becomes accustomed to the nipple shield, the infant becomes accustomed to the texture and scent of the nipple shield itself, rather than the natural breast texture and scent. As a result, infants will sometimes refuse to nurse without a nipple shield. Some known nipple shields, such as that disclosed in U.S. Pat. No. 8,469,771, have a concave recess along the upper portion of the base to allow the infant's nose to directly contact the breast on a specific side of the nipple shield. However, such nipple shields require parents to carefully orient the nipple shield in relation to the infant's nose and then maintain that position throughout the feeding, which can become extremely difficult when tired or when orienting the nipple shield and the baby in a darkened room.

Furthermore, nipple shields are typically transparent, thin, and small, and therefore easily lost. They can also be expensive. However, because the nipple shields are often indispensable for feeding an infant if the infant or mother has become dependent on them, losing a nipple shield can be very problematic and stressful for the parent, especially given the added expense. Parents therefore must buy multiple sets of nipple shields at a high cost or otherwise risk being unable to feed their infants.

Some nipple shields incorporate visibility characteristics to aid the user in locating nipple shields when not in use. However, these attempts at making the nipple shields more visible are problematic for the user. For instance, although the addition of phosphorescence allows the nipple shield to be visible in certain circumstances (i.e., in a dark room), it must be exposed to light at various intervals to be effective. Nipple shields commonly stored in a diaper bag, bedroom, or drawer would be ineffective at providing higher visibility in most circumstances. Parents attempting to use a phosphorescent nipple shield have the added burden of energizing the nipple shield to facilitate proper use. Furthermore, the phosphorescence interferes with the “natural”, unaided breastfeeding experience when it remains lit up while on the breast and the infant is feeding. Similarly, a nipple shield that is permanently colorful would be easier to find when not in use, but is disruptive and adds another unnatural element to the infant and mother's breastfeeding experience. This can hinder both acceptance of the nipple shield by the infant and/or refusal of the infant to nurse without the nipple shield. As a result, a colorful, “unnatural-looking” breast could be confusing to an infant and disruptive to the parent attempting to engage in a “natural” breastfeeding experience. As such, colorful nipple shields are not typically offered, at least in part because parents are still seeking a “natural” experience and often hope to wean their infants off the nipple shield.

### BRIEF DESCRIPTION OF THE DRAWINGS

Many aspects of the present disclosure can be better understood with reference to the following drawings. The components in the drawings are not necessarily to scale. Instead, emphasis is placed on clearly illustrating the principles of the present disclosure.

FIG. 1A is an isometric view of a thermochromic nipple shield configured in accordance with some embodiments of the present technology.

FIG. 1B is a top view of the thermochromic nipple shield of FIG. 1A in accordance with some embodiments of the present technology.

FIG. 1C is a partial cross-sectional view of the thermochromic nipple shield taken along line A-A of FIG. 1B in accordance with some embodiments of the present technology.

FIG. 2 is an isometric view of the thermochromic nipple shield of FIGS. 1A-1C when not in use in accordance with some embodiments of the present technology.

FIG. 3 is a side view of the thermochromic nipple shield of FIGS. 1A-2 positioned over a nipple in accordance with some embodiments of the present technology.

FIG. 4 is a block diagram of a method for manufacturing a thermochromic nipple shield in accordance with some embodiments of the present technology.

### DETAILED DESCRIPTION

The present technology is directed to thermochromic nipple shields and associated systems and methods. The disclosure is used to cover a nipple and surrounding area during breastfeeding. This disclosure creates a thin, textured, flexible barrier to allow the infant to feed and gain the sensory experience of feeding at the breast while alleviating some discomfort parents feel when nursing a baby. The barrier allows the parent and the infant to feel the contact necessary to effectively nurse. The nipple shield includes holes at the tip of the nipple cone and at the base of the cone to allow the infant to feed and breathe the scent of the parent. The nipple shield also includes a thermochromic dye to allow the barrier to change from brightly colored at or near room temperature to colorless and/or transparent at the body temperature. This thermochromic feature of the nipple shield may facilitate locating the nipple shields when the nipple shield is at room temperature (e.g., and not in use). In some embodiments, for example, the nipple shield also includes features that allow the nipple shield to be applied to a breast at any orientation. For example, the nipple shield can include a cone portion that receives a human nipple and a base portion with a plurality of holes symmetrically positioned around the cone portion. The nipple shield has thermochromic properties such that the nipple shield changes color at a certain threshold temperature. For example, the nipple shield may become brightly colored when it is below a specified temperature (e.g., below typical body temperatures) and not in use. When above a threshold temperature (e.g., a lower bound of a typical body temperature), the nipple shield can become colorless and/or transparent so as not to distract from a “natural breastfeeding experience” when the user brings the nipple shield to body temperature (e.g., by holding the nipple shield in one's hands, placing the nipple shield on the breast).

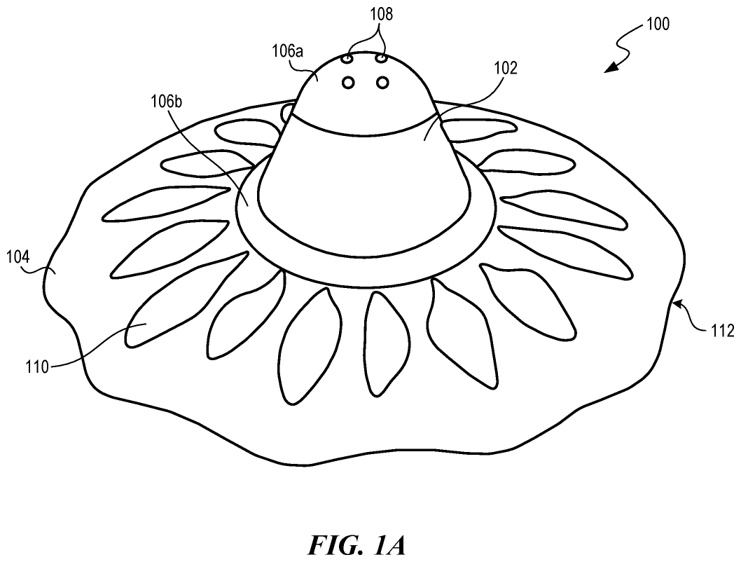

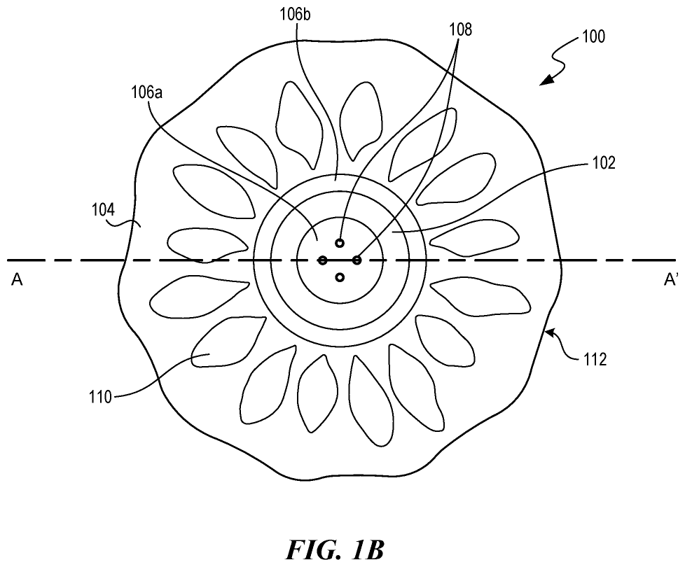

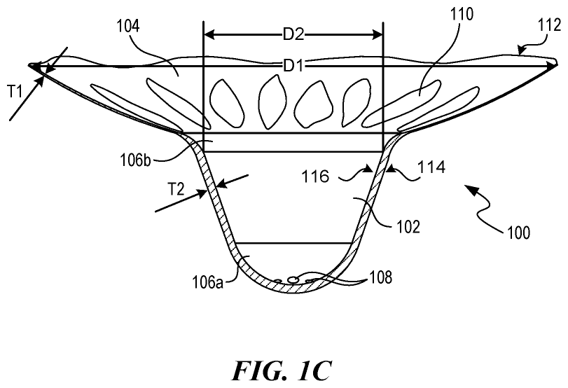

Specific details of several embodiments of the present technology are described herein with reference to FIGS. 1A-4. The present technology, however, can be practiced without some of these specific details. In some instances, well-known structures and techniques often associated with nipple shields and the like, have not been shown in detail so as not to obscure the present technology. The terminology used in the description presented below is intended to be interpreted in its broadest reasonable manner, even though it is being used in conjunction with a detailed description of certain specific embodiments of the disclosure. Certain terms can even be emphasized below; however, any terminology intended to be interpreted in any restricted manner will be overtly and specifically defined as such in this Detailed Description section.

The accompanying Figures depict embodiments of the present technology and are not intended to be limiting of its scope. The sizes of various depicted elements are not necessarily drawn to scale, and these various elements can be arbitrarily enlarged to improve legibility. Component details can be abstracted in the Figures to exclude details such as position of components and certain precise connections between such components when such details are unnecessary for a complete understanding of how to make and use the present technology. Many of the details, dimensions, angles, and other features shown in the Figures are merely illustrative of particular embodiments of the disclosure. Accordingly, other embodiments can have other details, dimensions, angles, and features without departing from the spirit or scope of the present technology.

In some embodiments, the nipple shield may include holes at a base and a texture to allow an infant to develop a familiarity with the sensations of unaided breastfeeding. When the disclosed nipple shield incorporates thermochromic characteristics, it allows users to readily access the nipple shield when needed because it is easy to see when not in use but it becomes colorless and/or transparent at body temperature so it does not interfere with or visually disrupt the breastfeeding experience. The enclosed figures depict the unique, innovative elements of the described disclosure.

As used herein, the term “transparent,” when used to describe a thermochromic material, refers to colorless material that allows visible light to pass through so that objects and features behind the material can be seen from the opposite side of the material without visible changes in color or with only negligible changes in color. For example, a material may be considered “transparent” even when the material appears somewhat foggy or misty (e.g., semi-transparent or translucent), as long as the coloration of objections on the other side remain undisturbed and some details remain visible.

FIGS. 1A-1C illustrate different views of a thermochromic nipple shield 100 (“nipple shield 100”) configured in accordance with some embodiments of the present technology. More specifically, FIG. 1A is an isometric view of the nipple shield 100, FIG. 1B is a top view of the nipple shield 100, and FIG. 1C is a cross-sectional view of the nipple shield 100 taken along a reference line A-A′ shown in FIG. 1B. The nipple shield 100 includes a cone portion 102 (also referred to as a “first portion” or a “nipple portion”) shaped to receive at least a portion of a human nipple and a base portion 104 (also referred to as a “second portion” or “breast portion”) surrounding the cone portion 102. The cone portion 102 has a first end region 106a spaced apart from the base portion 104 and a second end region 106b opposite the first end region 106b adjacent to the base portion 104. The first end region 106a includes one or multiple extraction holes 108 extending therethrough to allow fluid (e.g., breastmilk) to flow from within the cone portion 102 to outside the cone portion 102 (e.g., into an infant's mouth). The base portion 104 extends radially outwardly from the second end region 106b of the cone portion 102 to cover a portion of a human breast surrounding the nipple (e.g., the areola, portions of the breast surrounding the areola). The nipple shield 100 can conform comfortably to the shape of a mother's breast to provide a thin, flexible barrier that protects the mother's breast from discomfort and pain while an infant extracts milk from the mother's nipple during breastfeeding. The nipple shield 100 further includes one or more thermochromic features that cause the nipple shield 100 to change colors or become colorless and/or transparent depending on the temperature of the nipple shield 100. For example, the nipple shield 100 may transition to a specific color (e.g., blue, purple, red, green) at lower temperatures when not in use, and become colorless, transparent, and/or flesh colored (e.g., beige, brown, black, olive, pink) when heated near body temperature.

The cone portion 102 can have a generally circular cross-section that flairs radially outwardly from the first end region 106a to the second end region 106b to create a cone-like shape (e.g., similar to the widening of a nipple of a breastfeeding human). The first end region 106a may be rounded at its terminus to form a dome-like or hemispherical end (e.g., as shown in FIGS. 1A-1C), have curved edges to create a dome-like structure, and/or be shaped in another arrangement suitable for infant latching during breast feeding. The extraction holes 108 at the first end region 106a extend completely through the thickness of the cone portion 102, and can have various different sizes, shapes, and/or arrangements to accommodate breastfeeding. In the illustrated embodiment, for example, the nipple shield 100 includes four circular extraction holes 108 arranged in a square or diamond pattern. In some embodiments, the extraction holes 108 be defined by square, triangular, irregular shaped, and/or other shapes, and/or may be arranged in a circular, triangular, or random configuration at the first end region 106a. In some embodiments, the nipple shield 100 can include fewer than four extraction holes 108 or more than four extraction holes 108. The size of the extraction holes 108 can be pre-defined to be suitable for providing the infant an appropriate flow of breastmilk while suctioning. In various embodiments, the size, shape, quantity, and/or arrangement of the extraction holes 108 can depend on the stage of breastfeeding for the infant (e.g., to produce lesser flow at early stages and allow for higher flow during latter stages). Although the first portion 102 of the nipple shield 100 is shown in FIGS. 1A-1C to have a cone-like shape, in other embodiments, the first portion 102 can have an irregular shape, a column-like shape, and/or other suitable shape that can fit over at least a portion of a human nipple and suitable for breastfeeding. In these and other embodiments, the first portion 102 can be substantially conformal to at least partially take on the shape of the nipple inserted therein.

The base portion 104 can have a generally circular shape extending around the cone portion 102. In the embodiment illustrated in FIGS. 1A-1C, the base portion 104 has a peripheral edge 112 (e.g., the outermost edge of the base portion 104) with an irregular or wavy pattern (e.g., a “natural edge”). This irregular or wavy pattern can provide a more natural transition from the nipple shield 100 to the natural breast tissue, thereby causing the nipple shield 100 blend better with the parent's breast. The peripheral edge 112 can have differing curvatures than that shown in FIGS. 1A and 1B, the curvature of the peripheral edge 112 can be a uniform or a non-uniform along the peripheral edge 112, and/or the peripheral edge 112 can define a symmetrical or non-symmetrical shape of the base portion. For example, the peripheral edge 112 can define petal-like arms, semicircular extensions or indents, angular protrusions, and/or have one or more of these arrangements along different sections of the peripheral edge.

As shown in FIGS. 1A-1C, the base portion 104 can further include one or multiple ventilation openings 110 (also referred to as “apertures” or “holes”) that extend completely through the thickness of the base portion 104. The ventilation openings 110 can have different shapes, sizes, and/or arrangements along the base portion 104. In FIGS. 1A-1C the ventilation openings 110 have a petal-like shapes that are arranged in a circular configuration about the cone portion 102. In these and other embodiments, the ventilation openings 110 can have other shapes, such as circular, oval, polygonal, freeform shapes, and/or combinations thereof. The ventilation openings 110 may be arranged around the cone portion 102 in symmetrical manner (e.g., as shown in FIGS. 1A and 1B), may be asymmetrically positioned with respect to the cone portion 102 (e.g., positioned only along a specified portion, include more ventilation openings 110 along a select portion), and/or may positioned different distances apart from the cone portion 102 than shown in FIGS. 1A and 1B. For example, in some embodiments the ventilation openings 110 may be arranged at a peripheral region of the base portion 104 (e.g., near the outer edge of the nipple shield 100 spaced apart from the cone portion 102 by a distance). In some embodiments, the ventilation openings 110 may extend from the base portion 104 to the second end region 106b of the cone portion 102, and/or the cone portion 102 itself may include ventilation openings 110. The ventilation openings 110 may be arranged uniformly across the base portion 104 (e.g., as shown in FIGS. 1A and 1B) or in a non-uniform manner. In embodiments where the ventilation openings 110 are positioned in a generally symmetrical or uniform manner around the base portion 104, the orientation of the nipple shield 100 does not matter, and therefore simplifies use of the nipple shield 100 as the infant's mouth does not need to be oriented in a specific manner with respect to the nipple shield 100. When breastfeeding, the ventilation openings 110 allow the infant's nose or lips to touch the mother's skin, smell the mother's scent, and/or taste the mother's skin. Accordingly, the ventilation openings 110 can more closely align the infant's sensory input of an aided breastfeeding experience using the nipple shield 100 with unaided breastfeeding, thereby facilitating the transition between the two and providing a more natural breastfeeding experience. Further, the ventilation openings 110 may also facilitate nasal breathing for the feeding infant as the ventilation openings 110 provide gaps for air circulation between the infant's nose and the nipple shield material.

The nipple shield 100 can be thin and at least partially conformable to take on the shape of the breast and/or nipple to which it is attached. For example, the nipple shield 100 can have a thickness ranging from about 0.1 mm to about 1.5 mm, and in some embodiments the nipple shield 100 can have different and/or varying thickness along different portions. In certain embodiments, the thickness near the peripheral edge 112 of the base portion 104 can be thinner than the thickness at other portions of the nipple shield 100 (e.g., at the second end region 106b of the cone portion 102). In various embodiments, the thickness can increase gradually from the outermost edge of the base portion 104 toward the cone portion 102. For example, as shown in FIG. 1C, the nipple shield 100 has thickness T1 near the outermost edge of the base portion 104 and thickness T2 at the cone portion 102 that is greater than thickness T1. In some embodiments, the thickness T1 is 0.1 mm-0.8 mm (e.g., about 0.2 mm) and the thickness T2 is 0.8 mm-1.5 mm (e.g., about 1.1 mm).

The nipple shield 100 can have suitable dimensions for receiving a human nipple in the cone portion 102 and extending over a portion of the surrounding breast tissue so as to cover portions of the nipple and breast that an infant's mouth touches during breastfeed and/or the portions of the breast or nipple that typically become sore during breastfeeding. For example, the base portion 104 of the nipple shield 100 can have an outermost diameter or width between 60 mm and 100 mm, shown as diameter D1 in FIG. 1C. In other embodiments, the outermost diameter D1 can be less than 60 mm, greater than 100 mm, and/or the diameter can vary along the length of the nipple shield 100. The cone portion 102 has a smaller diameter or width than the base portion 104, and the diameter can decrease continuously or incrementally from a base cone diameter (D2 in FIG. 1C) at the second end region 106b to a tip cone diameter at the first end region 106a. In some embodiments, the cone diameter D2 can range from about 15 mm at the first end region 106a to about 30 mm at the second end region 106b of the cone portion 102. Nipple shields 100 can come in different predefined sizes based on their base cone diameters D2 (e.g., 17 mm, 24 mm, and 27 mm) to fit different nipple sizes. A breastfeeding woman may select the nipple shield 100 with the appropriately sized cone portion 102 for her nipple as nipple sizes vary among women and can change depending upon the stage of breastfeeding or time of day. Similarly, nipple shields 100 can be sized based on differing predefined base portion diameters D1 to provide varying degrees of coverage of the area surrounding the user's nipple.

The nipple shield 100 can be molded or otherwise formed from one or more flexible materials that are food-safe, BPA-free, and compatible with infant feeding and sterilization. For example, the nipple shield 100 may be made of silicone, such as medical-grade silicone. The nipple shield material (e.g., silicone) can be molded as a single integral structure using a single mold or other manufacturing procedure to form a single unitary structure. In some embodiments, portions of the nipple shield 100, such as the cone portion 102 and the base portion 104, are formed (e.g., molded) as separate components and fixedly secured together (via adhesives, heat-joining attachment techniques) to construct the nipple shield 100. In some embodiments, an infant-facing surface 114 shown in FIG. 1C (also referred to as an “external surface”) of the nipple shield 100 has a texture that is similar to or replicates the texture of human skin. The texture can allow the infant to feed without causing the mother discomfort while also allowing the infant to become accustomed to an unaided breastfeeding experience. This can be achieved by incorporating the texture in the mold itself, applying a coating to the surface, processing after the nipple shield has been formed (e.g., etching, surface treatments). The texturized infant-facing surface 114 more closely mimics the infant's sensory experience of natural breastfeeding, and is therefore expected to facilitate an infant's acceptance of the nipple shield 100 and the transition to unaided breastfeeding. In some embodiments, a breast-facing surface 116 shown in FIG. 1C (also referred to as an “internal surface”) of the nipple shield 100 can have a texture the same as or different from the infant-facing surface 114. For example, the breast-facing surface 116 can be textured to be comfortable and non-abrasive when pressed against the user's skin and/or have a texture that facilitates attachment or positioning of the nipple shield 100 against the breast. For example, the texture of the surface 116 can assist to hold the nipple shield 100 in contact with the breast while breastfeeding.

All or a portion of the nipple shield 100 can be made from a food-safe and BPA-free thermochromic material. Thermochromism refers to a material property that causes a material to change color and/or transparency due to a change in temperature. For example, a thermochromic material may appear to be at least partially opaque and have a visible color (e.g., as visually detected by a human) at a first temperature and be transparent (with no visible color) at a second temperature that is different from the first temperature. With respect to the nipple shield 100, one or more thermochromic dyes (also referred to as a “thermochromic pigment”), such as the thermochromic dyes manufactured by Kolortek Co., Ltd, of Jiangsu, China and Chromatic Technologies Inc. of Colorado Springs, Colo., can be mixed with a base material of the nipple shield 100, such as silicone. For example, a thermochromic dye can be mixed with silicone while in its liquid form such that the thermochromic dye is embedded throughout the silicone when the nipple shield 100 is formed, causing the entire nipple shield 100 to take on thermochromic properties. When the nipple shield 100 is formed from separate components joined together to make the nipple shield 100, one or more of the separate components may include thermochromic material and thermochromic features. In some of these embodiments, different components may include different thermochromic material, and therefore take on differing thermochromic colors depending upon the temperature.

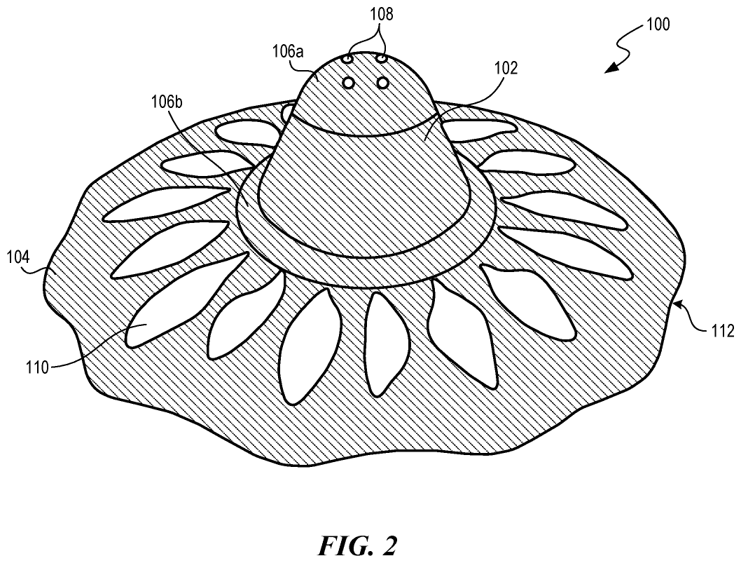

The thermochromic properties of the nipple shield 100 cause the nipple shield to be at least partially opaque and have a visible color (e.g., blue, purple, green, red, pink) at temperatures below a threshold temperature of the thermochromic material, and become at least substantially colorless and/or transparent at temperatures at or above the threshold temperature. The threshold temperature can be a specified temperature or temperature range where the change in color or transparency occurs. In some embodiments, for example, the threshold temperature of the nipple shield 100 is around body temperature (e.g., ranging from 97 degrees F. to 100 degrees F./36 degrees C. to 38 degrees C.). In some embodiments, the threshold temperature is 80 degrees F. (27 degrees C.), 85 degrees F. (30 degrees C.), 90 degrees F. (32 degrees C.), 95 degrees F. (35 degrees C.), 96 degrees F. (36 degrees C.), temperatures therebetween, higher than 96 degrees F., or lower than 80 degrees F. FIGS. 1A-1C illustrate the nipple shield 100 when it is at or above the threshold temperature, and therefore the nipple shield 100 is transparent. FIG. 2 illustrates the nipple shield 100 of FIGS. 1A-1C when it is below the threshold temperature and has a visible color (indicated by the pattern throughout the nipple shield 100).

In some embodiments, the thermochromic portion of the nipple shield 100 may be colorful and visible (e.g., at least partially opaque) at or below typical room temperatures (e.g., between 68 and 74 degrees F. (20-23.3 degrees C.) and transparent at temperatures above room temperature or above typical body temperatures (e.g., when the nipple shield is placed in contact with a human body). The nipple shield 100 is therefore transparent when at least partially in contact with human skin when positioned on the mother's nipple and the nipple shield 100 is colorful and visible (e.g., at least partially opaque) when not in use. For example, the nipple shield 100 is colorful when placed in a storage container, drawer, bag, counter, and/or washed with water that is below the threshold temperature. The color can makes the nipple shield 100 easy to locate when not in use (e.g., when stored away or being washed at a temperature below the body temperature). According to some embodiments, the thermochromic material of the nipple shield 100 may include one or more colors or shades, such as brightly colored to be easily seen in various conditions. Blue, pink, and purple are a set of non-limiting examples of colors that may be used because of the common associations of these colors with infants, calming and healing.

In some embodiments, the color of the thermochromic material of the nipple shield 100 is indicative of a size of the nipple shield 100. As discussed above, the nipple shields 100 disclosed herein can come in different sizes (e.g., different diameters D2 of the cone portion 102) to accommodate differently sized nipples and breasts during different stages of breastfeed and/or differently sized users. Accordingly, a first predefined size of the nipple shield 100 can have a first color (e.g., blue) below the threshold temperature, a second predefined size of the nipple shield 100 can have a second color (e.g., pink) below the threshold temperature, and a third predefined size of the nipple shield 100 can have a third color (e.g., purple) below the threshold temperature. Associating the color of the nipple shield 100 with the size allows the user to easily recognize the particular size they wish to use, without needing to look at small size indicators imprinted in the nipple shield and without needing to try it on for sizing. For example, a user may choose to use different-sized nipple shields at different times of the day or at different stages of breast feeding. An indicative color makes it easy to locate the nipple shield with the desired size, even when the user is tired or in a dimly lit room. The features of the nipple shield 100, such as including the patterned peripheral edge 112, the ventilation openings 110, textured surfaces 114 mimicking human skin, and the transparent appearance when positioned on the breast, may promote natural feeling breastfeeding experience for the mother as well as the infant. The features of the nipple shield 100 can further encourage easier transition away from the nipple shields when no longer needed to provide protection to the mother.

FIG. 2 is an isometric view of the nipple shield 100 of FIGS. 1A-1C with thermochromic color (depicted with a patterned shading of the nipple shield 100D) when not in use. According to some embodiments, the thermochromic dye may be incorporated throughout all or a majority of the nipple shield material to allow the nipple shield 100 to be clearly visible when not in use. According to one embodiment, at least a portion of the nipple shield, up to an entirety of the nipple shield, may include thermochromic material. In FIG. 2, the whole area of the nipple shield 100 includes the thermochromic material. In some embodiments, only the base portion 104 of the nipple shield 100 has the thermochromic color while the cone portion 102 is continuously transparent regardless of temperature. Alternatively, in some embodiments, at least a portion of the cone portion 102 may be thermochromic while the base portion 104 is continuously transparent. According to some embodiments, at least a portion of both the base portion 104 and the cone portion 102, up to an entirety of the nipple shield may be thermochromic.

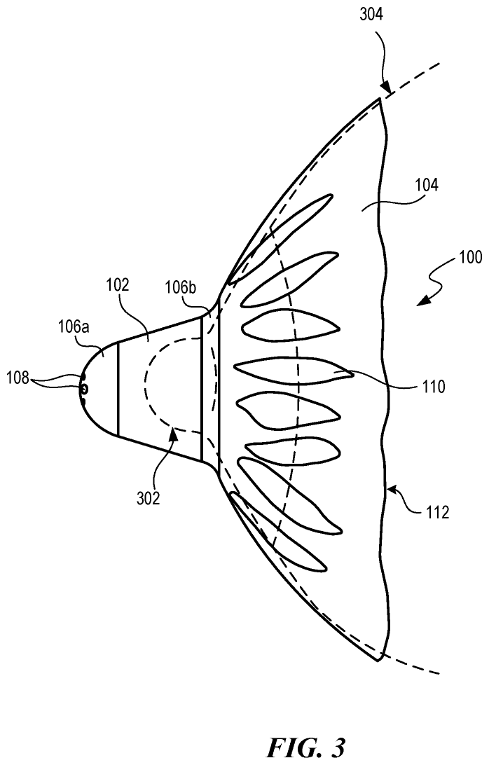

FIG. 3 is a side view of the nipple shield 100 of FIGS. 1A-2 when in use on a human breast 304 in accordance with embodiments of the present technology. The nipple shield 100 is positioned such that the cone portion 102 receives the nipple 302 and the base portion 104 contacts at least a portion of the breast 304 surround the nipple 302. As shown, the shape of the nipple shield 100 at least partially conforms to the shape of the breast 304 and the nipple 302, while covering the nipple 302 and a portion of the breast 304 to create a barrier between an infant's mouth and the user's breast 304. While positioned at least in partial contact with the breast 304 and the nipple 302, the temperature of the nipple shield 100 adjusts to the body temperature of the user (at or above the threshold temperature) and the nipple shield becomes fully transparent (e.g., the thermochromic portions of the nipple shield 100 are above the threshold temperature and thereby transparent). The transparent nipple shield 100 provides for a natural breastfeeding experience as the skin of the mother is visible through the nipple shield 100 during breastfeeding, rather than the nipple shield being an artificial, unnatural color.

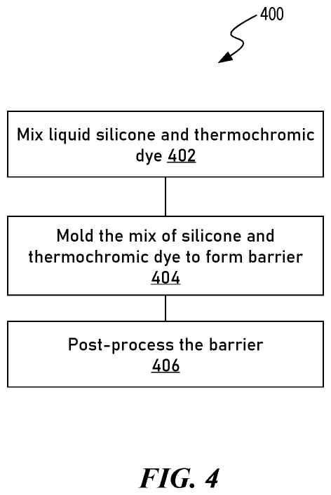

FIG. 4 is a block diagram of a method 400 of manufacturing a thermochromic nipple shield (e.g., the nipple shield 100 of FIGS. 1A-3) in accordance with embodiments of the present technology. The method 400 includes mixing a base material, such as liquid silicone, with thermochromic dye to form a thermochromic mixture (e.g., a silicone-dye mixture) (block 402). The silicone (e.g., liquid polymerized siloxane or polysiloxane) can include one or more silicone materials suitable for breastfeeding and sterilization, such as medical-grade or food-grade silicone. Optionally, the method 400 can include polymerization of siloxanes or polysiloxanes to form the liquid silicone prior to mixing the liquid silicone with the thermochromic dye. The polymerization can include, for example, hydrolysis of dimethyldichlorosilane. The mixing may be performed by mixing methods known in the art (e.g., by mechanical mixing). The volume ratio for the liquid silicone and to the thermochromic dye can be selected to provide the desired intensity and brightness of the color when the nipple shield has a temperature below the threshold temperature for the selected thermochromic dye. The method 400 can optionally also include addition of other additives to the thermochromic mixture. For example, such additives can be included to improve the durability of the nipple shield, provide anti-bacterial properties, stain repelling properties, differing textures to the mixture, and/or other properties for the manufactured nipple shield.

The method 400 also includes molding the thermochromic mixture to form a shape corresponding to the desired shape of the nipple shield (block 404). The mold can define the thickness, structure and dimensions of the nipple shield. For example, the mold can define a cone portion for receiving a nipple, a base portion extending from the cone portion and configured to lie against a human breast, textures on one or both sides of the nipple shield, extraction holes for permitting breast milk to pass through the cone portion, vent features, patterns along a peripheral edge of the nipple shield, and/or other features of the nipple shield (e.g., the specific features described with respect to FIGS. 1A-3). In some embodiments, the extraction holes, the ventilation openings, and/or peripheral edge features may be formed in the molded nipple shield after the molding step.

Molding can include molding techniques known in the art, such as compression molding, injection molding, or melt molding. Different portions of the nipple shield can be molded separately or integrally. For example, the cone portion 102 and the base portion 104 of the nipple shield can be integrally molded from a single mold and/or other processing technique. For example, a fully thermochromic nipple shield (e.g., the nipple shield 100 of FIGS. 1A-3) can be formed using a single mold and a single molding process. In other embodiments, the cone portion 102, the base portion 104, sections thereof, and/or additional components can be manufactured separately and joined together to form the nipple shield 100. For example, a partially thermochromic nipple shield having only one of the base portion and the cone portion made of the thermochromic material while the other portion is constantly transparent can be manufactured by manufacturing the cone portion and the base portion separately and then joining the portions together to form the partially thermochromic nipple shield. For example, the cone portion is molded from the thermochromic mixture prepared in block 403, the base portion is molded from the liquid silicone (without the thermochromic dye), and the cone portion and the base portion are joined to form a partially thermochromic nipple shield.

The method 400 can also include post-processing steps (block 406) of the molded nipple shield. The post processing can include curing the liquid silicone-thermochromic dye mixture to form a flexible, thin barrier of the nipple shield 100. The curing can include any curing techniques known in the art (e.g., ultraviolet (UV) light exposure, heat exposure, chemical curing, or drying). The curing of the nipple shield, for example, by UV light exposure can improve its durability. The post-processing can include adding texture to the one or two surfaces of the nipple shield (e.g., the surfaces 114 and 116). Adding the texture can include, for example, adding a coating on the one or two surfaces of the nipple shield by etching or carving the one or two surfaces. Optionally, the post-processing can further include generating openings (e.g., the extraction holes 108 and/or ventilation openings 110) by puncturing, carving, cutting, or drilling the molded silicone barrier.

### Embodiments

In accordance with some embodiments, a nipple shield for covering a nipple and surrounding area of a breast during breastfeeding includes a flexible, thin barrier. The barrier has a shape that conforms with the nipple and surrounding area of a person breastfeeding. The barrier includes a cone portion having a first end region and a second end region opposite the first end region. The first end region includes multiple extraction holes extending through a first end region of the cone portion to allow an infant to extract milk during breastfeeding. The barrier also includes a base portion extending radially outwardly from second end region and surrounding the cone portion. At least a portion of the barrier includes a thermochromic material configured to change visibility of the barrier at a threshold temperature, so that the thermochromic material is colorless and/or transparent when a temperature of the barrier is at or above a threshold temperature to allow visibility to the nipple through the cone portion while breastfeeding. The threshold temperature is above 20° C. and below 36.7° C. The thermochromic material is at least partially opaque and has a visible color when the temperature of the barrier is below the threshold temperature to allow locating the nipple shield when not used for breastfeeding.

In some embodiments, the barrier has an outer surface configured to face away from the breast. The outer surface has a texture that replicates human skin.

In some embodiments, the base portion includes a plurality of ventilation openings extending completely through the barrier.

In some embodiments, the base portion includes an irregular peripheral edge.

In some embodiments, the base portion includes a plurality of ventilation openings radiating outwardly from the second end region. The plurality of ventilation openings extend circumferentially around the cone portion.

In accordance with some embodiments, a nipple shield for covering a nipple and surrounding area during breastfeeding includes a cone portion having a first end region and a second end region spaced apart from the first end region. The first end region has plurality of extraction holes extending therethrough. A base portion surrounds the cone portion and extends radially outwardly from the second end region of the cone portion. The cone portion and the base portion include a thermochromic material. The thermochromic material has a visible color when a temperature of the nipple shield is below a threshold temperature and the thermochromic material is colorless and/or transparent when the temperature of the nipple shield is at or above the threshold temperature.

In some embodiments, the base portion defines multiple ventilation openings extending completely therethrough. The ventilation openings are positioned to surround the cone portion from all sides of the cone portion.

In some embodiments, the ventilation openings have a petal or oval shape. The ventilation openings are arranged in a circular configuration around the cone portion.

In some embodiments, the base portion includes a peripheral edge with a wave-like pattern.

In some embodiments, the nipple shield has a first surface configured to be at least partially in contact with the nipple and the surrounding area during breastfeeding. The nipple shield has a second surface opposite to the first surface and configured to face away from the breast during breastfeeding. The second surface has a first texture configured to replicate human skin.

In accordance with some embodiments, the first surface has a second texture that is different from the first texture.

In some embodiments, when the thermochromic materials is below the threshold temperature, the visible color of the thermochromic material is at least partially opaque.

In some embodiments, the nipple shield includes a silicone material. The thermochromic material includes a thermochromic dye embedded throughout the silicone material.

In some embodiments, the threshold temperature is 35° C. or above. In some embodiments, the threshold temperature is at or above 26° C.

In some embodiments, the visible color of the nipple shield, which is visible when the temperature of the nipple shield is below the threshold temperature, is indicative of a predefined size of the nipple shield.

In accordance with some embodiments, a method of manufacturing thermochromic nipple shields includes mixing a liquid silicone and a thermochromic dye to form a silicone-dye mixture. The method includes molding the silicone-dye mixture to form a nipple shield defining a flexible, thin barrier during breastfeeding. The nipple shield includes a cone portion having a first end region and a second end region spaced apart from the first end region. The first end region has plurality of extraction holes extending therethrough. The nipple shield also has a base portion surrounding the cone portion and extending radially outwardly from the second end region of the cone portion. After molding, the nipple shield with the thermochromic dye is configured to have a visible color when a temperature of the nipple shield is below a threshold temperature and the nipple shield is configured to be colorless and/or transparent when the temperature of the nipple shield is at or above the threshold temperature. The threshold temperature is 26° C. or higher.

In some embodiments, the molding step includes forming at least one textured surface replicating human skin on an outward-facing surface of the nipple shield.

In some embodiments, molding the silicone-dye mixture includes forming a plurality of ventilation openings extending through the base portion.

In some embodiments, molding the silicone-dye mixture includes forming a wavy or irregular peripheral edge along the base portion.

### CONCLUSION

The above detailed description of embodiments of the technology are not intended to be exhaustive or to limit the technology to the precise form disclosed above. Although specific embodiments of, and examples for, the technology are described above for illustrative purposes, various equivalent modifications are possible within the scope of the technology as those skilled in the relevant art will recognize. For example, although steps are presented in a given order, alternative embodiments can perform steps in a different order. The various embodiments described herein can also be combined to provide further embodiments.

From the foregoing, it will be appreciated that specific embodiments of the technology have been described herein for purposes of illustration, but well-known structures and functions have not been shown or described in detail to avoid unnecessarily obscuring the description of the embodiments of the technology. Where the context permits, singular or plural terms can also include the plural or singular term, respectively.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Additionally, the term “comprising” is used throughout to mean including at least the recited feature(s) such that any greater number of the same feature and/or additional types of other features are not precluded. It will also be appreciated that specific embodiments have been described herein for purposes of illustration, but that various modifications can be made without deviating from the technology. Further, while advantages associated with some embodiments of the technology have been described in the context of those embodiments, other embodiments can also exhibit such advantages, and not all embodiments need necessarily exhibit such advantages to fall within the scope of the technology. Accordingly, the disclosure and associated technology can encompass other embodiments not expressly shown or described herein.

I/We claim:

1. A nipple shield for covering a nipple and surrounding area of a breast during breastfeeding, the nipple shield comprising:
a flexible, thin barrier having a shape that conforms with the nipple and surrounding area of a person breastfeeding, the barrier comprising:
a cone portion having a first end region and a second end region opposite the first end region, the first end region comprising multiple extraction holes extending through a first end region of the cone portion to allow an infant to extract milk during breastfeeding; and
a base portion extending radially outwardly from second end region and surrounding the cone portion,
wherein at least a portion of the barrier comprises a thermochromic material configured to change visibility of the barrier at a threshold temperature such that—
the thermochromic material is transparent when a temperature of the barrier is at or above a threshold temperature, wherein the threshold temperature is above 20° C. and below 36.7° C. to allow visibility to the nipple through the cone portion while breastfeeding; and
the thermochromic material is at least partially opaque and has a visible color when the temperature of the barrier is below the threshold temperature to allow locating the nipple shield when not used for breastfeeding.

2. The nipple shield of claim 1, wherein the barrier has an outer surface configured to face away from the breast, and wherein the outer surface has a texture that replicates human skin.

3. The nipple shield of claim 1, wherein the base portion comprises a plurality of ventilation openings extending completely through the barrier.

4. The nipple shield of claim 1, wherein the base portion comprises an irregular peripheral edge.

5. The nipple shield of claim 1, wherein the base portion comprises a plurality of ventilation openings radiating outwardly from the second end region, wherein the plurality of ventilation openings extend circumferentially around the cone portion.

6. A nipple shield for covering a nipple and surrounding of a breast area during breastfeeding, the nipple shield comprising:
a cone portion having a first end region and a second end region spaced apart from the first end region, the first end region having plurality of extraction holes extending therethrough; and
a base portion surrounding the cone portion and extending radially outwardly from the second end region of the cone portion,
wherein the cone portion and the base portion comprise a thermochromic material, and wherein—
the thermochromic material has a visible color when a temperature of the nipple shield is below a threshold temperature, and
the thermochromic material is transparent when the temperature of the nipple shield is at or above the threshold temperature.

7. The nipple shield of claim 6, wherein the base portion defines multiple ventilation openings extending completely therethrough, the ventilation openings positioned to surround the cone portion from all sides of the cone portion.

8. The nipple shield of claim 7, wherein:
the ventilation openings have a petal or oval shape; and
the ventilation openings are arranged in a circular configuration around the cone portion.

9. The nipple shield of claim 6, wherein the base portion comprises a peripheral edge with a wave-like pattern.

10. The nipple shield of claim 6, wherein the nipple shield has:
a first surface configured to be at least partially in contact with the nipple and the surrounding area during breastfeeding; and
a second surface opposite to the first surface and configured to face away from the breast during breastfeeding, wherein the second surface has a first texture configured to replicate human skin.

11. The nipple shield of claim 10, wherein the first surface has a second texture that is different from the first texture.

12. The nipple shield of claim 6, wherein, when the thermochromic materials is below the threshold temperature, the visible color of the thermochromic material is at least partially opaque.

13. The nipple shield of claim 6, wherein:
the nipple shield comprises a silicone material, and
the thermochromic material comprises a thermochromic dye embedded throughout the silicone material.

14. The nipple shield of claim 6, wherein the threshold temperature is 35° C. or above.

15. The nipple shield of any claim 6, wherein the threshold temperature is at or above 26° C.

16. The nipple shield of any claim 6, wherein:
the visible color of the nipple shield, which is visible when the temperature of the nipple shield is below the threshold temperature, is indicative of a predefined size of the nipple shield.

17. A method of manufacturing thermochromic nipple shields, the method comprising:
mixing a liquid silicone and a thermochromic dye to form a silicone-dye mixture; and
molding the silicone-dye mixture to form a nipple shield defining a flexible, thin barrier during breastfeeding, the nipple shield including:
a cone portion having a first end region and a second end region spaced apart from the first end region, the first end region having plurality of extraction holes extending therethrough; and
a base portion surrounding the cone portion and extending radially outwardly from the second end region of the cone portion,
wherein, after molding,
the nipple shield with the thermochromic dye is configured to have a visible color when a temperature of the nipple shield is below a threshold temperature, and
the nipple shield is configured to be transparent when the temperature of the nipple shield is at or above the threshold temperature, wherein the threshold temperature is 26° C. or higher.

18. The method of claim 17, wherein the molding step includes forming at least one textured surface replicating human skin on an outward-facing surface of the nipple shield.

19. The method of claim 17, wherein molding the silicone-dye mixture comprises forming a plurality of ventilation openings extending through the base portion.

20. The method of claim 17, wherein molding the silicone-dye mixture comprises forming a wavy or irregular peripheral edge along the base portion.
